(19) United States
(12) Patent Application Publication
(10) Pub. No.: US 2025/0216831 A1
(43) Pub. Date: Jul. 3, 2025

(54) CONTROL SYSTEM, CONTROL METHOD OF CONTROL SYSTEM, AND CONTROL PROGRAM OF CONTROL SYSTEM

(71) Applicant: MITSUBISHI HEAVY INDUSTRIES, LTD., Tokyo (JP)

(72) Inventors: Shinichi TODA, Kanagawa (JP); Minoru NAKAIDE, Tokyo (JP)

(21) Appl. No.: 18/989,664

(22) Filed: Dec. 20, 2024

(30) Foreign Application Priority Data
Dec. 28, 2023 (JP) 2023-222293

(51) Int. Cl. G05B 19/05

(52) U.S. Cl. CPC G05B 19/05

(57) ABSTRACT

The present application relates to a control system including a plurality of controllers that have a plurality of CPU cores configured to execute a logic calculation including a plurality of calculation tasks that control a control target and are multiplexed with each other. Each of the plurality of controllers stores a calculation result of the plurality of calculation tasks as a first local data array, and stores a calculation result received from another controller as a second local data array. A data element selected from the first local data array and the second local data array is stored as a global data array referable to among the plurality of calculation tasks. The first local data array is transmitted to another controller as tracking data.

### CROSS-REFERENCE TO RELATED APPLICATIONS

This application claims the benefit of priority to Japanese Patent Application Number 2023-222293 filed on Dec. 28, 2023. The entire contents of the above-identified application are hereby incorporated by reference.

### TECHNICAL FIELD

The present disclosure relates to a control system, a control method of a control system, and a control program for a control system.

### RELATED ART

A control system for controlling a plant facility such as a power generation plant includes a controller including a processing unit such as a CPU. In this type of controller, a field signal from a field device such as a sensor installed in a plant facility that is a control target is input, a control logic including a plurality of logic sheets described in a graphic language (or a function block diagram (FBD) language of IEC61131-3 in an international standard language of a programmable logic controller (PLC)) such as a problem oriented language (POL) is executed, and a calculation result thereof is output to operation terminals such as actuators and switches, thereby controlling the plant facility. Such a series of calculation processing by the controller is periodically executed according to a predetermined calculation cycle.

Meanwhile, this type of control system may be configured to include controllers that are multiplexed with each other in order to improve reliability. In a system in which controllers are multiplexed, even when a malfunction such as a failure occurs in a controller in a control state, a control function can be maintained by switching to another controller in a standby state. In such a system in which controllers are multiplexed, there is a system having a means for synchronizing calculation results of control logics between the controllers so that an output to an operation terminal does not suddenly change when the controller is switched (for example, JP 2003-65004 A).

### SUMMARY

In a control system including a calculation processing unit, a controller having a plurality of CPU cores (multi-core CPU) may be used in order to improve the calculation performance. In such a controller, the calculation of each logic sheet included in a control logic is executed in parallel by the plurality of CPU cores, but there is a possibility that a difference occurs in a logic calculation result between the multiplexed controllers depending on the processing execution state of each CPU core. When there is a difference in the logic calculation result between the multiplexed controllers, there is a concern that an output value to the operation terminal may suddenly change at the time of switching to the standby side controller. Therefore, in a control system having a multiplexed controller, even if the controller has a plurality of CPU cores, a control logic calculation is executed by a single CPU core so as not to cause a difference in a calculation result between the controllers, and the merit of the multi-core CPU is not sufficiently utilized at present.

In addition, the logic calculation performed as the calculation processing in the control system has been advanced in recent years. For example, there is already a mechanism in which advanced control such as model predictive control (MPC) or advanced calculation processing such as an artificial intelligence (AI) is described in a general-purpose programming language such as C or Python, and a function in an object code thereof is called from a control logic and executed. However, in a case in which such a logic calculation is performed by a single CPU core, a processing time in a convergence calculation or a learning processing for obtaining an optimal solution by an iterative calculation becomes long, and thus there is a concern that a logic calculation result cannot be output to an operation terminal within a control cycle defined in advance.

At least one embodiment of the present disclosure has been made in view of the above-described circumstances, and an object thereof is to provide a control system, a control method of a control system, and a control program for a control system that can suitably perform control based on an advanced logic calculation using a multiplexed controller including a plurality of CPU cores.

In order to solve the above problem,
a control system according to at least one embodiment of the present disclosure includes a plurality of controllers including a plurality of CPU cores configured to execute a logic calculation including a plurality of calculation tasks that control a control target, the plurality of controllers being multiplexed with each other, wherein
each of the plurality of controllers includes:
a first local data array storage area configured to store a calculation result of the plurality of calculation tasks as a first local data array;
a second local data array storage area configured to store the calculation result received from another controller as a second local data array;
a global data array storage area configured to store a data element selected from the first local data array and the second local data array as a global data array referable to among the plurality of calculation tasks; and
a tracking data transmission unit configured to transmit the first local data array to the other controller as tracking data.

In order to solve the above problem,
in a control method of a control system according to at least one embodiment of the present disclosure, the control system includes a plurality of controllers including a plurality of CPU cores configured to execute a logic calculation including a plurality of calculation tasks that control a control target, the plurality of controllers being multiplexed with each other, the control method includes:

in each of the plurality of controllers,
storing a calculation result of the plurality of calculation tasks as a first local data array;
storing the calculation result received from another controller as a second local data array;
storing a data element selected from the first local data array and the second local data array as a global data array referable to among the plurality of calculation tasks; and
transmitting the first local data array to the other controller as tracking data.

In order to solve the above problem,
in a non-transitory computer readable storage medium storing a control program for a control system according to at least one embodiment of the present disclosure, the control system includes a plurality of controllers including a plurality of CPU cores configured to execute a logic calculation including a plurality of calculation tasks that control a control target, the plurality of controllers being multiplexed with each other, the control program causes a computer device to execute the steps of:
in each of the plurality of controllers,
storing a calculation result of the plurality of calculation tasks as a first local data array;
storing the calculation result received from another controller as a second local data array;
storing a data element selected from the first local data array and the second local data array as a global data array referable to among the plurality of calculation tasks; and
transmitting the first local data array to the other controller as tracking data.

According to at least one embodiment of the present disclosure, it is possible to provide a control system, a control method of a control system, and a control program of a control system that can suitably perform control based on an advanced logic calculation using a multiplexed controller including a plurality of CPU cores.

### BRIEF DESCRIPTION OF DRAWINGS

The disclosure will be described with reference to the accompanying drawings, wherein like numbers reference like elements.

FIG. 1 is a schematic diagram illustrating an overall configuration of a control system according to an embodiment.

FIG. 2 is a schematic diagram illustrating a configuration of a controller unit in FIG. 1.

FIG. 3 is a schematic internal configuration diagram of a controller in FIG. 2.

FIG. 4 is a flowchart illustrating a control method of the control system of FIG. 1.

### DESCRIPTION OF EMBODIMENTS

Hereinafter, some embodiments of the disclosure will be described with reference to the accompanying drawings.

However, configurations described in the embodiments or illustrated in the drawings shall be interpreted as illustrative only and not intended to limit the scope of the disclosure thereto.

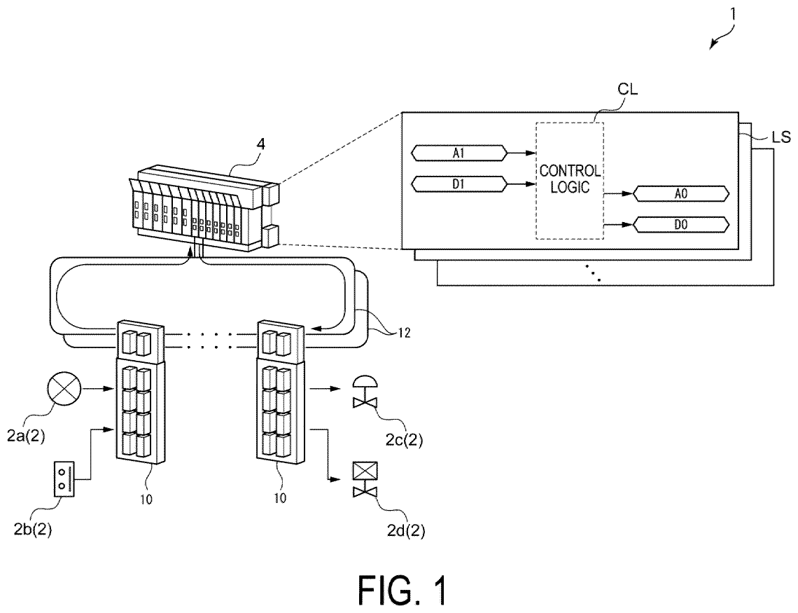

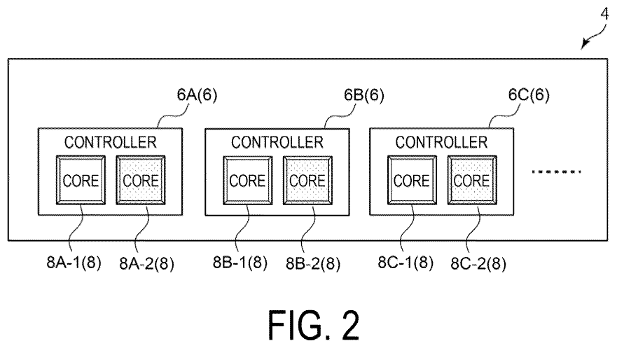

First, a schematic configuration of a control system 1 according to an embodiment will be described with reference to FIGS. 1 and 2. FIG. 1 is a schematic diagram illustrating an overall configuration of the control system 1 according to an embodiment, and FIG. 2 is a schematic diagram illustrating a configuration of a controller unit 4 of FIG. 1.

In the control system 1, a plant facility including a large number of devices is a control target 2. A specific configuration of the control target 2 is not limited, but the control target 2 is, for example, a plant facility constituting an infrastructure such as oil, gas, electric power, and manufacturing. In FIG. 1, a transmitter 2a, a switching sensor 2b, a control valve 2c, and a shut-off valve 2d, which are constituent devices of the plant facility, are illustrated as some examples of the control target 2.

The control system 1 includes the controller unit 4 that can realize various functions for controlling the control target 2.

The controller unit 4 includes a plurality of controllers 6 as will be described below (in the following description, when the plurality of controllers 6 included in the controller unit 4 are distinguished from each other, they are appropriately referred to as controllers 6A, 6B, . . . ). Each controller 6 includes, for example, a central processing unit (CPU), a random access memory (RAM), a read only memory (ROM), a computer-readable storage medium, and the like. A series of processing for realizing the various functions is stored in a storage medium or the like as a control program, and the CPU reads the control program into the RAM or the like and executes information processing, thereby realizing the various functions. Particularly in the present embodiment, the control program is prepared as a plurality of logic sheets LS including a control logic CL described in a graphic language.

The control program may be installed in advance in a ROM or another storage medium, may be provided in a state of being stored in a computer-readable storage medium, or may be distributed via a wired or wireless communication unit. The computer-readable storage medium includes a magnetic disk, a magneto-optical disk, a CD-ROM, a DVD-ROM, and a semiconductor memory.

The plurality of controllers 6 included in the controller unit 4 are multiplexed with each other. The multiplicity of the plurality of controllers 6 is two or more. Each of the plurality of multiplexed controllers 6 has substantially the same configuration, and one of a control mode in which the control target 2 can be controlled and a standby mode can be selected as an execution mode. In the controller unit 4, any one controller 6A selected from the plurality of controllers 6 is set to the control mode to control the control target 2, and the other controllers 6B, 6C, . . . are set to the standby mode. When an event in which the control of the control target 2 cannot be continued for some reason occurs in the controller 6A in the control mode, the execution mode of the controller 6A is switched from the control mode to the exclusion or serious failure mode, and the execution mode of any one of the other controllers 6B, 6C, . . . is switched from the standby mode to the control mode, so that the control of the control target 2 can be continued.

Further, each of the plurality of controllers 6 included in the controller unit 4 is a so-called multi-core CPU type having a plurality of CPU cores 8 as a CPU for performing a logic calculation including a plurality of calculation tasks by executing a control program. Each controller 6 includes two or more CPU cores 8, but the example of FIG. 2 illustrates a case in which each controller 6 includes two CPU cores 8 (for example, the controller 6A includes CPU cores 8A-1 and 8A-2, and the controller 6B includes CPU cores 8B-1 and 8B-2).

Each controller 6 can transmit and receive various types of information necessary for calculation processing to and from the control target 2 via an I/O unit 10. The I/O unit 10 is an input/output interface for inputting and outputting various types of information between the controller 6 and the control target 2, and is connected to the controller 6 via an I/O communication network 12. Input information from the control target 2 is taken into the controller 6 via the I/O unit 10, and is input to the plurality of logic sheets LS installed in advance in each controller 6. The input information (analog data or digital data) input to each logic sheet LS is used for the calculation of the control logic CL described in POL, and the calculation result (analog data or digital data) is output. The calculation result output from each logic sheet LS is output as a control signal to the control target 2 via the I/O unit 10.

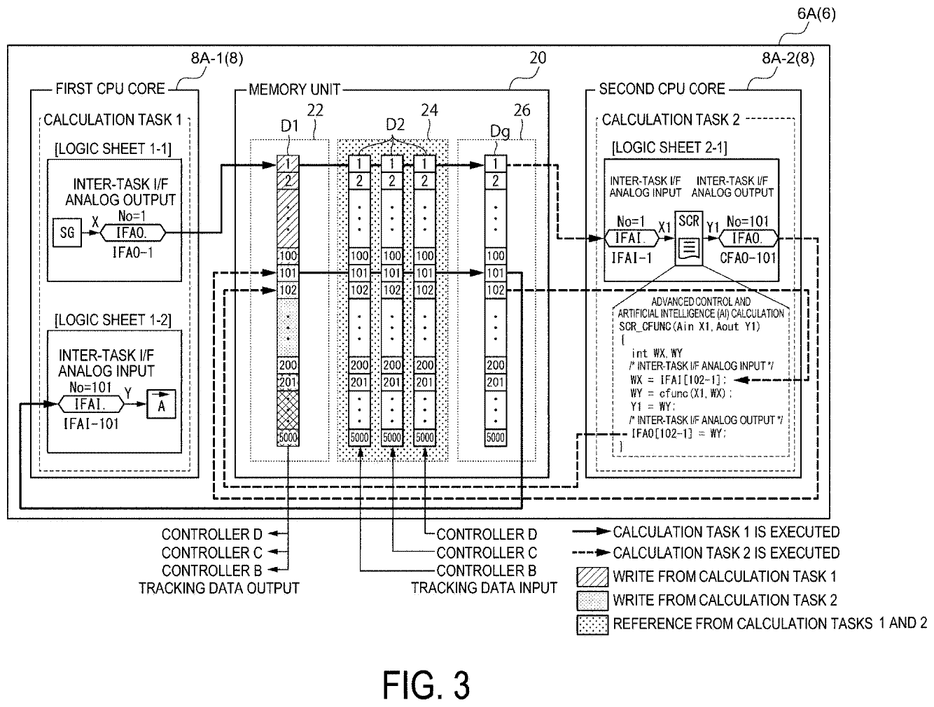

Subsequently, a functional configuration of each controller 6 in the control system 1 having the above configuration will be described. FIG. 3 is an internal configuration diagram of the controller 6 in FIG. 2. In the following description, the controller 6A among the plurality of controllers 6 included in the controller unit 4 will be representatively described, but the same applies to the other controllers 6B, 6C, . . . unless otherwise specified.

The controller 6A includes a first CPU core 8A-1, a second CPU core 8A-2, and a memory unit 20. The first CPU core 8A-1 and the second CPU core 8A-2 execute a plurality of calculation tasks corresponding to the plurality of logic sheets LS installed in advance as described above. The memory unit 20 includes a first local data array storage area 22, a second local data array storage area 24, and a global data array storage area 26.

In the controller 6A, calculation tasks to be executed by the respective CPU cores 8 (the first CPU core 8A-1 and the second CPU core 8A-2) included in the controller 6A are created based on the plurality of logic sheets LS installed in advance. A control cycle corresponding to the control logic CL included in each of the plurality of logic sheets LS is defined. The controller 6A divides the plurality of logic sheets LS into logic sheet groups LSG for each control cycle, creates a calculation task (hereinafter referred to as a “calculation task 1”) for calculating the logic sheet group LSG having the shortest control cycle among the logic sheet groups LSG, and allocates the calculation task 1 to the first CPU core 8A-1.

In addition, the controller 6A creates calculation tasks for executing logic sheet groups other than the logic sheet group included in the calculation task 1 as calculation tasks N (N=2, 3, . . . ) in ascending order of the control cycle. Here, the control cycle of the calculation task N is n (n=1, 2, . . . ) times the control cycle of the calculation task 1.

Here, the plurality of logic sheets LS executed by the controller 6A include, for example, not a small number of control logics CLs for executing general-purpose programs that require a large amount of computation, such as convergence calculations that seek optimal solutions by iterative calculations and artificial intelligence (AI). Since such a logic sheet LS having a huge amount of calculation has a relatively long control cycle and there is a possibility that the calculation is not completed within a predetermined control cycle, the logic sheet LS is not included in the calculation task 1 and is allocated to the logic sheet group LSG so as to be executed in a calculation task N (for example, a calculation task 2) different from the calculation task 1.

The controllers 6A, 6B, . . . included in the controller unit 4 are synchronized with each other in the execution timing of a specific calculation task. In the present embodiment, as will be described below, the execution timing of the calculation task 1 having the shortest control cycle among the plurality of calculation tasks is synchronized between the CPU cores 8A-1, 8B-1, . . . on one side of the controllers 6A, 6B. After the execution of the calculation task 1, the calculation task N (N=2, 3, . . . ) is woken up from the calculation task 1 at a predetermined timing, and is executed by the other CPU cores 8A-2, 8B-2, . . . of the controllers 6A, 6B.

The first local data array storage area 22 is configured to store, as a first local data array D1, the calculation results of a plurality of calculation tasks executed by the controller 6A. That is, in each calculation task executed in the controller 6A, an intermediate calculation value or a final calculation value transferred to other calculation tasks are stored as specified data elements in the first local data array storage area 22. FIG. 3 illustrates an example in which the calculation result of the logic sheet LS1-1 executed by the first CPU core 8A-1 is stored in a data element 1 of the first local data array D1, and the calculation result of the logic sheet LS2-1 executed by the second CPU core 8A-2 is stored in data elements 101 and 102. Each data element stored in the first local data array D1 in this manner is transmitted to the other controllers 6B, 6C, . . . as tracking data.

The second local data array storage area 24 is configured to store, as the second local data array D2, the calculation results that are received as tracking data from the other controllers 6B, 6C, . . . and are referable to among the plurality of calculation tasks. That is, the calculation results corresponding to each data element of the first local data array D1 are received from the other controllers 6B, 6C, . . . and stored in each data element of the second local data array D2. In FIG. 3, the second local data array storage area 24 has a plurality of second local data arrays D2 corresponding to the other controllers 6B, 6C, . . . , respectively. To be more specific, in data elements of the second local data array D2 corresponding to the other controller 6B, the calculation results received as tracking data from the controller 6B are stored. In addition, in data elements of the second local data array D2 corresponding to the other controller 6C, the calculation results received as tracking data from the controller 6C are stored.

The global data array storage area 26 includes a global data array Dg that can store a data element selected from the first local data array D1 and the second local data array D2. The data element of the global data array Dg stores the result of comparing the data element of the first local data array D1 and the data element of the second local data array D2. Here, the data element to be stored as the data element of the global data array Dg is input and selected according to a predetermined rule such that the multiplexed controllers 6A, 6 B, . . . will produce the same calculation results. For example, each data element in the global data array Dg may store an intermediate value between the data element in the first local data array D1 and the data element in the second local data array D2. Furthermore, each data element of the global data array Dg may store a value selected as the most frequent value (i.e., by majority vote) among the data element of the first local data array D1 and the data element of the second local data array D2. Each data element stored in this manner in the global data array Dg is transmitted to each calculation task performed by the controller 6A as a calculation result referable to among the plurality of calculation tasks.

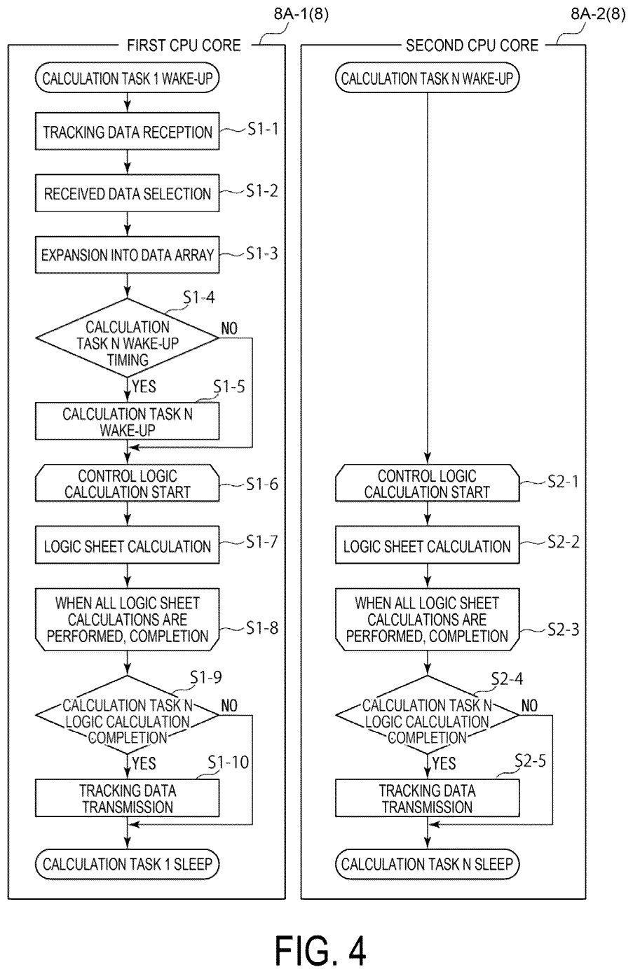

Subsequently, a control method of the control system 1 having the above configuration will be described. FIG. 4 is a flowchart illustrating a control method of the control system 1 of FIG. 1. In FIG. 4, the two CPU cores 8A-1 and 8A-2 included in the controller 6A sequentially perform processing related to the calculation tasks 1 and N. The processing performed by the other controllers 6B, 6C, . . . is the same as that performed by the controller 6A unless otherwise specified.

In each of the multiplexed controllers 6A, 6B, . . . , the calculation task 1 is synchronously executed. In the controller 6A, when the calculation task 1 is executed in synchronization with the other controllers 6B, 6C, . . . , in the first CPU core 8A-1 that executes the calculation task 1, each data element stored in the first local data arrays D1 of the other controllers 6B, 6C, . . . is received as tracking data (step S1-1). Each of these data elements received as tracking data is stored in the second local data array D2 of the controller 6A, and the result of selected the data elements from the first local data array D1 and the second local data array D2 is stored in the global data array Dg, as described above (step S1-2). Each data element stored in the global data array Dg can be referred to in a plurality of calculation tasks in the controller 6A as a calculation result referred to among the plurality of calculation tasks (step S1-3).

Subsequently, in the first CPU core 8A-1, it is determined whether or not it is the wake-up timing of the calculation task N in the other second CPU core 8A-2 of the controller 6A (step S1-4). When it is the wake-up timing of the calculation task N in the second CPU core 8A-2 (step S1-4: YES, the calculation task N (N=2, 3, . . . ) is woken up in the second CPU core 8A-2 independent of the first CPU core 8A-1 (step S1-5). As a result, the first CPU core 8A-1 starts the calculation of the control logic corresponding to the calculation task 1 (step S1-6), and the second CPU core 8A-2 starts the calculation of the control logic corresponding to the calculation task N (step S2-1).

When it is not the wake-up timing of the calculation task N in the second CPU core 8A-2 (step S1-4: NO), that is, when the calculation of the logic sheet of the calculation task N is not completed in the second CPU core 8A-2, the calculation task N is not woken up.

Subsequently, in the first CPU core 8A-1, the calculation of each logic sheet corresponding to the calculation task 1 is executed (step S1-7). In step S1-7, in the first CPU core 8A-1, the calculation tasks are interfaced by the POL elements described in each logic sheet, i.e., InterFace Analog Input (IFAI) and InterFace Analog Output (IFAO). By referring to the global data array Dg stored in the global data array storage area 26, data elements necessary for the calculation can be input to the input elements among these dedicated POL elements. The output element stores the calculation result in the first local data array storage area 22, which is a local buffer, as the first local data array D1.

In the first CPU core 8A-1, when the calculations of all the logic sheets are completed (step S1-8), the first CPU core 8A-1 determines whether or not the logic calculation of the calculation task N in the second CPU core 8A-2 on the other side is completed (step S1-9).

In the determination of step S1-8, the processing is returned to step S1-6 until the calculations of all the logic sheets are completed, whereby the calculation of the next logic sheet is performed. Such processing is repeated until the calculations of all the logic sheets are completed. Then, when the first CPU core 8A-1 confirms the completion of the calculation task N (step S1-9: YES), each data element stored in the first local data array D1 is transmitted as tracking data to the other controllers 6B, 6C, . . . (step S1-10).

In the second CPU core 8A-2, the calculation of the logic sheet corresponding to the calculation task N is performed (step S2-2). In step S2-2, in the second CPU core 8A-2, the calculation tasks are interfaced by InterFace Analog Input (IFAI) and InterFace Analog Output (IFAO), which are POL elements described in each logic sheet. By referring to the global data array Dg stored in the global data array storage area 26, data elements necessary for the calculation can be input to the input elements among these dedicated POL elements. The output element stores the calculation result in the first local data array storage area 22, which is a local buffer, as the first local data array D1.

In the second CPU core 8A-2, when the calculations of all the logic sheets are completed (step S2-3), the second CPU core 8A-2 determines whether or not the logic calculation of the calculation task 1 in the first CPU core 8A-1 is completed (step S2-4). Then, when the second CPU core 8A-2 confirms the completion of the calculation task 1 (step S204: YES), each data element stored in the first local data array D1 is transmitted as tracking data to the other controllers 6B, 6C, . . . (step S2-5). The transmission timing of the tracking data is set to the time when the calculations of both the calculation tasks 1 and N are completed so as not to transmit the state in the middle of the calculation in each calculation task.

In the determination of step S2-3, the processing is returned to step S2-1 until the calculations of all the logic sheets are completed, whereby the calculation of the next logic sheet is performed. Such processing is repeated until the calculations of all the logic sheets are completed.

As described above, according to the above embodiment, in each of the multiplexed controllers 6 including a plurality of CPU cores, the calculation results of a plurality of calculation tasks are stored as the first local data array D1. Each data element stored in the first local data array D1 is stored in a second local data array D2 of another controller 6 as tracking data. In the second local data array D2, each data element received as the tracking data from the first local data array D1 of the other controller 6 is stored. In the global data array Dg, the data elements selected from the first local data array D1 and the second local data array D2 stored as described above are stored, and can be referred to in the calculations of the plurality of calculation tasks in the controller 6. Accordingly, since a difference does not occur in the calculation results of the respective controllers 6 having the plurality of CPU cores, even in a case in which control switching to another controller 6 is performed when a malfunction or the like occurs in a specific controller 6, a sudden change does not occur in the output signal to the control target. As a result, it is possible to suitably perform control based on advanced logic calculation using the multiplexed controller 6 including a plurality of CPU cores.

In addition, it is possible to replace the components in the above-described embodiments with well-known components as appropriate without departing from the essence of the present disclosure, and the above-described embodiments may be combined as appropriate.

The contents described in each of the above embodiments are understood as follows, for example.
(1) A control system according to one aspect includes a plurality of controllers including a plurality of CPU cores configured to execute a logic calculation including a plurality of calculation tasks that control a control target, the plurality of controllers being multiplexed with each other, wherein
each of the plurality of controllers includes:
a first local data array storage area configured to store a calculation result of the plurality of calculation tasks as a first local data array;
a second local data array storage area configured to store the calculation result received from another controller as a second local data array;
a global data array storage area configured to store a data element selected from the first local data array and the second local data array as a global data array referable to among the plurality of calculation tasks; and
a tracking data transmission unit configured to transmit the first local data array to the other controller as tracking data.

According to the aspect of (1), in each of the multiplexed controllers including the plurality of CPU cores, the calculation results of the plurality of calculation tasks are stored as the first local data array. Each data element stored in the first local data array is stored in the second local data array of the other controller by being transmitted to the other controller as tracking data. Each data element received as tracking data from the first local data array of another controller is stored in the second local data array. In the global data array, the data elements selected from the first local data array and the second local data array stored as described above are stored, and can be referred to in the calculations of the plurality of calculation tasks in the controller. Accordingly, since a difference does not occur in the calculation results of the respective controllers having the plurality of CPU cores, even in a case in which control switching to another controller is performed when a malfunction or the like occurs in a specific controller, a sudden change does not occur in the output signal to the control target. As a result, it is possible to suitably perform control based on advanced logic calculation using the multiplexed controller including a plurality of CPU cores.
(2) In another aspect, in the above aspect (1),
the global data array is selected to have an intermediate value of the first local data array and the second local data array.

According to the aspect of (2), by adopting the intermediate value of the first local data array and the second local data array as the global data array, it is possible to effectively prevent a difference from occurring in the calculation result of each controller.
(3) In another aspect, in the above aspect (1) or (2),
the plurality of calculation tasks include:
a first calculation task of executing a logic sheet group having a shortest control cycle among a plurality of logic sheet groups obtained by dividing, for each control cycle, a plurality of logic sheets included in the controller in which the logic calculation is executable; and
an N-th calculation task (where N=2, 3, . . . ) having a control cycle that is n times (n=1, 2, . . . ) the control cycle of the first calculation task, the N-th calculation task executing the plurality of logic sheet groups in ascending order of the control cycle.

According to the aspect of (3), when a plurality of calculation tasks including the first calculation task and the N-th calculation task are executed in a plurality of CPU cores, it is possible to effectively prevent a difference from occurring in calculation results between the multiplexed controllers.
(4) In another aspect, in the above aspect (3),
the plurality of CPU cores include:
a first CPU core configured to execute the first calculation task; and
a second CPU core configured to execute the N-th calculation task.

According to the above aspect (4), the first calculation task including the logic sheet group having the shortest control cycle is assigned to the first CPU core, and the other N-th calculation task is assigned to the second CPU core. This enables efficient calculation in a control system in which a controller including a plurality of CPU cores is multiplexed.
(5) In another aspect, in the above aspect (4),
the plurality of controllers are configured to synchronize execution timing of the first calculation task in the first CPU core.

According to the aspect of (5) described above, in each of the multiplexed controllers, the execution timing of the first calculation task in the first CPU core is controlled to be synchronized.
(6) In another aspect, in the above aspect (4),
the N-th calculation task in the second CPU core is woken up by the first calculation task executed in the first CPU core.

According to the aspect of (6), in each of the multiplexed controllers, the N-th calculation task executed by the first CPU core is controlled to be woken up by the first calculation task executed by the second CPU core.
(7) In another aspect, in any one of the above aspects (1) to (6),
the plurality of calculation tasks include a calculation having a processing time equal to or longer than a predetermined value.

According to the aspect of (7), the calculation logic including the calculation target having a possibility of exceeding the control cycle assumed in advance due to the processing time becoming equal to or greater than the predetermined value, such as the convergence calculation or the learning calculation, can be suitably calculated by the control system including the multiplexed controller having the plurality of CPU cores.
(8) In a control method of a control system according to one aspect,
the control system includes a plurality of controllers including a plurality of CPU cores configured to execute a logic calculation including a plurality of calculation tasks that control a control target, the plurality of controllers being multiplexed with each other, the control method includes:
in each of the plurality of controllers,
storing a calculation result of the plurality of calculation tasks as a first local data array;
storing the calculation result received from another controller as a second local data array;
storing a data element selected from the first local data array and the second local data array as a global data array referable to among the plurality of calculation tasks; and
transmitting the first local data array to the other controller as tracking data.

According to the aspect of (8), in each of the multiplexed controllers including the plurality of CPU cores, the calculation results of the plurality of calculation tasks are stored as the first local data array. Each data element stored in the first local data array is stored in the second local data array of the other controller by being transmitted to the other controller as tracking data. Each data element received as tracking data from the first local data array of another controller is stored in the second local data array. In the global data array, the data elements selected from the first local data array and the second local data array stored as described above are stored, and can be referred to in the calculations of the plurality of calculation tasks in the controller. Accordingly, since a difference does not occur in the calculation results of the respective controllers having the plurality of CPU cores, even in a case in which control switching to another controller is performed when a malfunction or the like occurs in a specific controller, a sudden change does not occur in the output signal to the control target. As a result, it is possible to suitably perform control based on advanced logic calculation using the multiplexed controller including a plurality of CPU cores.
(9) In a non-transitory computer readable storage medium storing a control program for a control system according to one aspect, the control system includes a plurality of controllers including a plurality of CPU cores configured to execute a logic calculation including a plurality of calculation tasks that control a control target, the plurality of controllers being multiplexed with each other, the control program causes a computer device to execute the steps of:

in each of the plurality of controllers
storing a calculation result of the plurality of calculation tasks as a first local data array;
storing the calculation result received from another controller as a second local data array;
storing a data element selected from the first local data array and the second local data array as a global data array referable to among the plurality of calculation tasks; and
transmitting the first local data array to the other controller as tracking data.

According to the aspect of (9), in each of the multiplexed controllers including the plurality of CPU cores, the calculation results of the plurality of calculation tasks are stored as the first local data array. Each data element stored in the first local data array is stored in the second local data array of the other controller by being transmitted to the other controller as tracking data. Each data element received as tracking data from the first local data array of another controller is stored in the second local data array. In the global data array, the data elements selected from the first local data array and the second local data array stored as described above are stored, and can be referred to in the calculations of the plurality of calculation tasks in the controller. Accordingly, since a difference does not occur in the calculation results of the respective controllers having the plurality of CPU cores, even in a case in which control switching to another controller is performed when a malfunction or the like occurs in a specific controller, a sudden change does not occur in the output signal to the control target. As a result, it is possible to suitably perform control based on advanced logic calculation using the multiplexed controller including a plurality of CPU cores.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A control system comprising:
a plurality of controllers including a plurality of CPU cores configured to execute a logic calculation including a plurality of calculation tasks that control a control target, the plurality of controllers being multiplexed with each other, wherein
each of the plurality of controllers includes:
a first local data array storage area configured to store a calculation result of the plurality of calculation tasks as a first local data array;
a second local data array storage area configured to store the calculation result received from another controller as a second local data array;
a global data array storage area configured to store a data element selected from the first local data array and the second local data array as a global data array referable to among the plurality of calculation tasks; and
a tracking data transmission unit configured to transmit the first local data array to the other controller as tracking data.

2. The control system according to claim 1, wherein
the global data array is selected to have an intermediate value of the first local data array and the second local data array.

3. The control system according to claim 1, wherein
the plurality of calculation tasks include:
a first calculation task of executing a logic sheet group having a shortest control cycle among a plurality of logic sheet groups obtained by dividing, for each control cycle, a plurality of logic sheets included in the controller in which the logic calculation is executable; and
an N-th calculation task (where N=2, 3, . . . ) having a control cycle that is n times (n=1, 2, . . . ) the control cycle of the first calculation task, the N-th calculation task executing the plurality of logic sheet groups in ascending order of the control cycle.

4. The control system according to claim 3, wherein
the plurality of CPU cores include:
a first CPU core configured to execute the first calculation task; and
a second CPU core configured to execute the N-th calculation task.

5. The control system according to claim 4, wherein
the plurality of controllers are configured to synchronize execution timing of the first calculation task in the first CPU core.

6. The control system according to claim 4, wherein
the N-th calculation task in the second CPU core is woken up by the first calculation task executed in the first CPU core.

7. The control system according to claim 1, wherein
the plurality of calculation tasks include a calculation having a processing time equal to or longer than a predetermined value.

8. A control method of a control system comprising a plurality of controllers including a plurality of CPU cores configured to execute a logic calculation including a plurality of calculation tasks that control a control target, the plurality of controllers being multiplexed with each other, the control method comprising:
in each of the plurality of controllers,
storing a calculation result of the plurality of calculation tasks as a first local data array;
storing the calculation result received from another controller as a second local data array;
storing a data element selected from the first local data array and the second local data array as a global data array referable to among the plurality of calculation tasks; and
transmitting the first local data array to the other controller as tracking data.

9. A non-transitory computer readable storage medium storing a control program for a control system comprising a plurality of controllers including a plurality of CPU cores configured to execute a logic calculation including a plurality of calculation tasks that control a control target, the plurality of controllers being multiplexed with each other, the control program causing a computer device to execute the steps of:
in each of the plurality of controllers,
storing a calculation result of the plurality of calculation tasks as a first local data array;
storing the calculation result received from another controller as a second local data array;
storing a data element selected from the first local data array and the second local data array as a global data array referable to among the plurality of calculation tasks; and
transmitting the first local data array to the other controller as tracking data.
